(19) United States
(12) Patent Application Publication
(10) Pub. No.: US 2016/0092873 A1
(43) Pub. Date: Mar. 31, 2016

(54) SYSTEMS AND METHODS FOR PROCESSING AND MONITORING REBATES

(71) Applicant: MasterCard International Incorporated, Purchase, NY (US)

(72) Inventor: Erica Robeen, Hardin, IL (US)

(21) Appl. No.: 14/502,846

(22) Filed: Sep. 30, 2014

(51) Int. Cl. G06Q 20/40; G06Q 20/34; G06Q 30/02

(52) U.S. Cl. CPC G06Q 20/40; G06Q 30/0234; G06Q 20/34

(57) ABSTRACT

A computer-based method for processing and monitoring rebates associated with a cardholder is provided. The method includes storing data including a plurality of cardholder profiles each associated with a cardholder enrolled in a rebate monitoring service and a plurality of payment card identifiers each associated with one of the cardholders. The method also includes receiving a first authorization request message for a first payment transaction initiated by a first cardholder. The first authorization request message includes a first payment card identifier. The method further includes determining a first cardholder profile associated with the first cardholder for the rebate monitoring service based in part on the first payment card identifier and the stored data, determining at least a first rebate associated with the first payment transaction, generating a completed rebate form based in part on the first cardholder profile and the first payment transaction, and transmitting the completed rebate form.

### BACKGROUND OF THE DISCLOSURE

The field of the disclosure relates generally to processing rebates, and more specifically to methods and systems for automatically completing rebate forms based on cardholder profiles and transaction information.

Many manufacturers, and some stores, offer rebates on items or services purchased. A rebate is an offer to provide money back to an individual who purchased an item or service. To apply for a rebate on a purchased item or service, the individual usually has to fill out a form and submit the form to the organization offering the rebate. Many times, to apply for the rebate the individual also needs to submit a copy of the receipt showing the purchase of the item. In some cases, the individual is also required to send in a copy of the UPC code or a picture of the code. When the rebates are submitted, the rebates are generally processed and the individual receives their money in about four to eight weeks. Many rebates are only valid for a limited time or require the individual to submit the rebate within a certain amount of time of the date of purchase. Rebates generally provide the rebated money in the form of a check or a prepaid payment card.

Many potential rebates are lost due to individuals forgetting to fill out and send in the paperwork, not filling out the rebate properly, not sending in the rebate in the required time frame, losing the required materials, or not even knowing about the rebate. Further, an individual may properly submit the rebate form and still fail to receive the money. With the long delay between submitting a rebate form and when the rebated money is supposed to be received, many individuals may forget that they have submitted rebates and fail to follow-up if the rebated money does not arrive.

Most commonly, the purchaser sends the rebate form and related “proof of purchase” items not to the manufacturer but to one of several large clearinghouses hired by the manufacturer to handle these transactions. The rebate clearinghouse then processes the form and sends the purchaser a check in the manufacturer's name, usually within four to eight weeks from the time the purchaser mails in the required information.

### BRIEF DESCRIPTION OF THE DISCLOSURE

In one aspect, a computer-based method for processing and monitoring rebates associated with a cardholder is provided. The method is implemented using a rebate computing device in communication with a memory. The method includes storing data within the memory including (i) a plurality of cardholder profiles each associated with a cardholder enrolled in a rebate monitoring service, and (ii) a plurality of payment card identifiers each associated with one of the cardholders. The method also includes receiving a first authorization request message for a first payment transaction initiated by a first cardholder using a first payment card at a first merchant. The first authorization request message includes a first payment card identifier. The method further includes determining by the computing device a first cardholder profile associated with the first cardholder for the rebate monitoring service based in part on the first payment card identifier and the data stored in the memory, determining by the computing device at least a first rebate associated with the first payment transaction, generating by the computing device a completed rebate form based in part on the first cardholder profile and the first payment transaction, and transmitting the completed rebate form.

In another aspect, a rebate computer system for processing and monitoring rebates associated with a cardholder is provided. The computer system includes a memory device for storing data, and one or more processors in communication with the memory device. The one or more processors are programmed to store data within the memory device including (i) a plurality of cardholder profiles each associated with a cardholder enrolled in a rebate monitoring service, and (ii) a plurality of payment card identifiers each associated with one of the cardholders. The one or more processors are also programmed to receive a first authorization request message for a first payment transaction initiated by a first cardholder using a first payment card at a first merchant. The first authorization request message includes a first payment card identifier. The one or more processors are further programmed to determine a first cardholder profile associated with the first cardholder for the rebate monitoring service based in part on the first payment card identifier and the data stored in the memory device, determine at least a first rebate associated with the first payment transaction, generate a completed rebate form based in part on the first cardholder profile and the first payment transaction, and transmit the completed rebate form.

In yet another aspect, a computer-readable storage medium having computer-executable instructions embodied thereon is provided. When executed by a computing device having at least one processor coupled to a memory device, the computer-executable instructions cause the processor to store data within the memory device including (i) a plurality of cardholder profiles each associated with a cardholder enrolled in a rebate monitoring service, and (ii) a plurality of payment card identifiers each associated with one of the cardholders. The computer-executable instructions also cause the processor to receive a first authorization request message for a first payment transaction initiated by a first cardholder using a first payment card at a first merchant. The first authorization request message includes a first payment card identifier. The computer-executable instructions further cause the processor to determine a first cardholder profile associated with the first cardholder for the rebate monitoring service based in part on the first payment card identifier and the data stored in the memory device, determine at least a first rebate associated with the first payment transaction, generate a completed rebate form based in part on the first cardholder profile and the first payment transaction, and transmit the completed rebate form.

### BRIEF DESCRIPTION OF THE DRAWINGS

FIGS. 1-7 show example embodiments of the methods and systems described herein.

FIG. 1 is a schematic diagram illustrating an example multi-party transaction card industry system for enabling ordinary payment-by-card transactions in which merchants and card issuers do not need to have a one-to-one special relationship.

FIG. 2 is a simplified block diagram of an example computer system used for completing rebate forms from cardholder transactions in accordance with one example embodiment of the present disclosure.

FIG. 3 illustrates an example configuration of the client system shown in FIG. 2, in accordance with one embodiment of the present disclosure.

FIG. 4 illustrates an example configuration of the server system shown in FIG. 2, in accordance with one embodiment of the present disclosure.

FIG. 5 is a block diagram illustrating an example of a system for registering a cardholder, monitoring a cardholder's payment transactions, completing rebate forms, and monitoring rebates using the system shown in FIG. 2, in accordance with one embodiment of the disclosure.

FIG. 6 is a flowchart illustrating an example process of processing a payment transaction that contains an item that is eligible for a rebate using the system shown in FIG. 2, in accordance with one embodiment of the disclosure.

FIG. 7 is a diagram of components of one or more example computing devices that may be used in the system shown in FIG. 2.

### DETAILED DESCRIPTION OF THE DISCLOSURE

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, methods and systems for completing rebate forms based on cardholder transactions. A rebate processing and monitoring (“RPM”) computing device monitors the payment transactions of registered cardholders. If a registered cardholder makes a purchase that qualifies for a rebate, then the RPM computing device completes the rebate forms associated with that purchase. The RPM computing device submits the completed rebate forms and monitors the rebate as it is processed.

In the example embodiment, a cardholder registers for a rebate monitoring service via the RPM computing device. The RPM computing device receives registration information from the cardholder via a client system. In the example embodiment, the RPM computing device provides a webpage interface for the cardholder to register through. The RPM computing device enrolls the cardholder in the rebate monitoring service, creates a cardholder profile based on the registration information, and associates the cardholder profile with at least one payment card identifier. The RPM computing device stores the cardholder profile in a database. The cardholder may update the information in the cardholder profile by logging into the webpage interface provided by the RPM computing device. The registration data contains information required for the RPM computing device to identify the cardholder and to fill out the rebate forms. Registration information may include, but is not limited to, username, password, name, physical address, e-mail address, phone number, desire to opt-in for mailings, and one or more unique payment card identifiers, such as the cardholder's payment card number.

The RPM computing device monitors payment transactions initiated by cardholder for items or services purchased by the cardholder that qualify for rebates. In some embodiments, the RPM computing device receives, stores, and maintains a list of available rebate offers provided by a rebate clearinghouse. In other embodiments, the RPM computing device queries the rebate clearinghouse about individual items in a payment transaction. In the example embodiment, the RPM computing device monitors cardholder payment transactions by receiving authorization request messages from a payment processing network. In other embodiments, the RPM computing device provides the payment processing network with a list of cardholders that registered for the rebate monitoring service and receives from the payment processing network every payment transaction, or a small subset of payment transactions, initiated by each registered cardholder's payment card including any available additional data about the payment transaction.

The cardholder tenders payment for a purchase from a merchant with a payment account card. For example, tendering of payment may be done at a point of sale system. The merchant sends an authorization request that contains transaction data, including a payment card identifier, of the payment transaction to the payment processing network. In the example embodiment, the payment processing network transmits the transaction data from the authorization request to the RPM computing device. In other embodiments, the RPM computing device may be a part of the payment processing network and receive the authorization request as a part of normal payment transaction processing.

Using the payment card identifier associated with the payment transaction, the RPM computing device queries the database to determine if the payment card identifier is associated with a cardholder profile. If the determination is yes, then the RPM computing device requests additional information about the payment transaction from the merchant. In the example embodiment, the payment processing network includes this request with the authorization code approving the payment transaction. In the example embodiment, the merchant transmits the additional information about only the items purchased that are eligible for a rebate to the RPM computing device. This additional information may include, but is not limited to, UPC codes, product listings, and copies of the receipt. In other embodiments, the merchant transmits additional information about all of the items purchased and the RPM computing device compares the items purchase to the stored list of available rebate offers to determine which items are eligible for rebates.

In the example embodiment, once RPM computing device determines which purchased items are eligible for rebates, the RPM computing device requests the required rebate form fields from the rebate clearinghouse for each eligible item. In other embodiments, the RPM computing device stores the required rebate form fields in the database and retrieves the rebate form fields for the eligible items.

For each eligible item, the RPM computing device completes the rebate form corresponding to the eligible item. The RPM computing device uses the payment transaction, the additional information received from the merchant, and the cardholder profile to fill in the fields of the rebate form. If there are fields that the RPM computing device lacks the information to complete, then the RPM computing device requests that information from the cardholder. This request may be sent to the cardholder via e-mail, text message, or other communication method. In the case of some rebates, the physical copy of the UPC code from the packaging of the item purchased may be required to process the rebate. In these cases, the RPM computing device will instruct the cardholder where to send the UPC code to. In other cases, only a picture of the UPC code from the packaging may be necessary and the RPM computing device receives the picture from the cardholder.

Once the RPM computing device has competed all of the required fields, the RPM computing device transmits the completed rebate form. In the example embodiment, the RPM computing device transmits the completed form directly to the rebate clearinghouse for processing. In other embodiments, the RPM computing device transmits the completed rebate form to the payment processing network, which then transmits the completed rebate form to the rebate clearinghouse. In still other embodiments, the RPM computing device transmits the completed rebate form directly to the manufacturer that is offering the rebate. In this application, the term “manufacturer” is used to refer to any organization, such as a manufacturer, merchant, or store that offers a rebate for purchased goods or services.

The RPM computing device periodically communicates with the rebate clearinghouse or the manufacturer to determine the status of the rebate. When the cardholder logs onto the RPM computing device, the RPM computing device displays the current status of every rebate associated with the cardholder. In some embodiments, the RPM computing device also transmits updates directly to the cardholder via e-mail, text, or other communication methods. These updates may be sent when the status of a rebate changes or periodically.

Some rebates require the purchase of multiple items; therefore, in some embodiments the RPM computing device tracks the items and services purchased by the cardholder. When the cardholder reaches the required number of items, the RPM computing device completes the corresponding rebate form and submits the completed form to the rebate clearinghouse. For example, if the cardholder purchased three boxes of cereal and the rebate is for purchasing four boxes, then the RPM computing device stores the payment transaction and additional information for the purchase of the boxes. When the cardholder purchases the fourth box, the RPM computing device combines the two payment transactions and submits the rebate.

In some embodiments, when the merchant is processing a return, the RPM computing device receives a request from the merchant. The request is an inquiry if a rebate has been processed for returning cardholder on the item or items being returned. The RPM computing device transmits the existence of a rebate in process or completed to the requesting merchant.

In other embodiments, the RPM computing device instructs the rebate clearinghouse to transmit the rebate to the payment processing network instead of the cardholder. The RPM computing device instructs the payment processing network to credit the cardholder's account by the amount of the rebate. In this manner, the cardholder receives the rebate money immediately as the payment processing network advances the cardholder the rebate amount.

The methods and systems described herein may be implemented using computer programming or engineering techniques including computer software, firmware, hardware, or any combination or subset wherein a technical effect of the systems and processes described herein is achieved. One of the problems with known systems and methods is that they don't provide for completing and monitoring rebates that may be associated with purchases by consumers. The technical computer systems described herein provide systems and methods for completing and monitoring rebates by performing at least one of the following steps: (a) receiving registration information from a cardholder, including one or more of username, password, name, physical address, e-mail address, phone number, desire to opt-in for mailings, and one or more unique payment card identifiers; (b) enrolling the cardholder in a rebate monitoring service; (c) storing data within a memory including (i) a cardholder profile associated with the cardholder being enrolled in the rebate monitoring service, and (ii) a corresponding payment card identifier associated with the cardholder; (d) receiving a first authorization request message for a first payment transaction initiated by a first cardholder using a first payment card at a first merchant, the first authorization request message including a first merchant identifier and a first payment card identifier, the first payment card identifier is associated with the first payment card issued by an issuing bank to the first cardholder; (e) determining a cardholder profile associated with the first cardholder for the rebate monitoring service based in part on the first payment card identifier and the data stored in the memory; (f) transmitting to the first merchant a request for a list of one or more items purchased in the first transaction; (g) receiving from the first merchant the list of one or more items purchased in the first transaction; (h) determining for each item on the list of one or more items purchased whether a rebate is associated with the purchase of that item; (i) determining at least one rebate associated with at least part of the first payment transaction; (j) determining one or more fields of a rebate form that cannot be filled out based on the first payment transaction or the cardholder profile associated with the first cardholder; (k) transmitting to the first cardholder a request to provide information to fill out the one or more fields; (l) receiving from the first cardholder the information to fill out the one or more fields; (m) determining that a physical proof of purchase is required to complete a rebate form; (n) transmitting to the first cardholder instructions for sending the physical proof of purchase; (o) generating a completed rebate form based in part on the cardholder profile and the first payment transaction; (p) transmitting the completed rebate form; (q) storing a status of a rebate associated with a cardholder profile; (r) transmitting a request for the update of the status of the rebate; (s) receiving an update of the status of the rebate; and (t) transmitting the updated status of the rebate to the cardholder associated with the cardholder profile.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

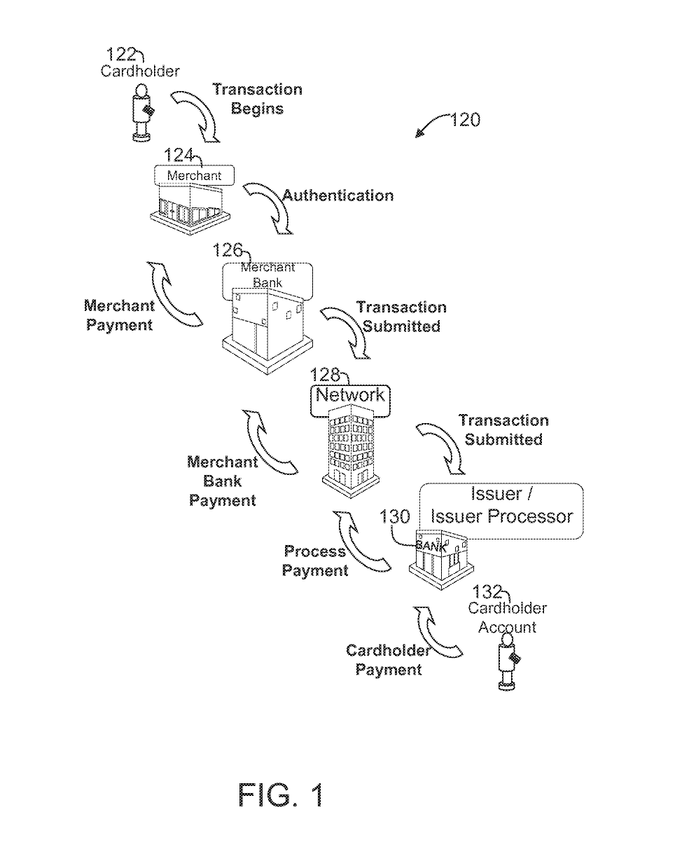

FIG. 1 is a schematic diagram illustrating an example multi-party transaction card industry system 120 for enabling ordinary payment-by-card transactions in which merchants 124 and card issuers 130 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” When cardholder 122 tenders payment for a purchase with a transaction card, merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

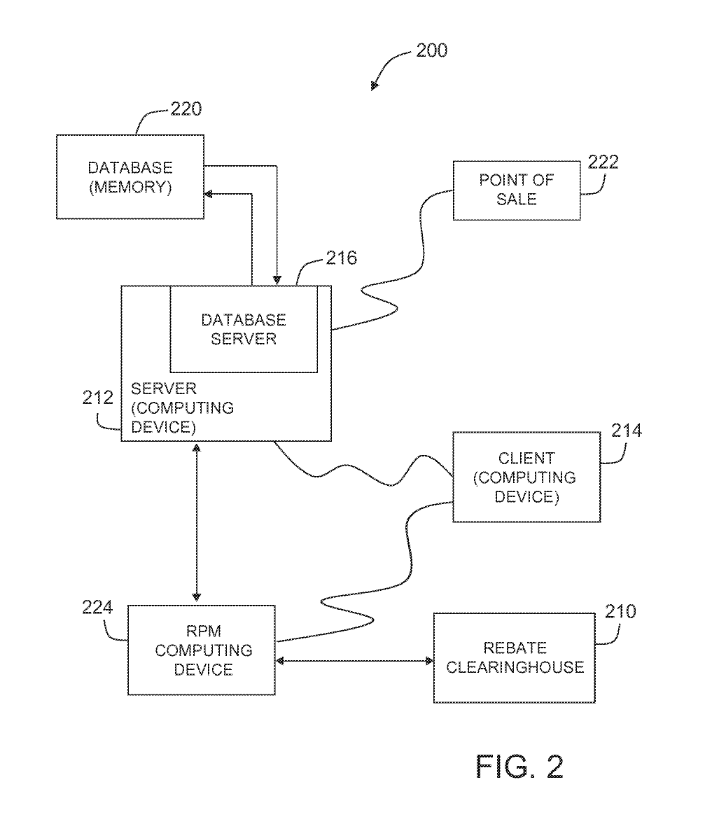

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 220.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

FIG. 2 is a simplified block diagram of an example system 200 used for completing rebate forms from cardholder transactions in accordance with one example embodiment of the present disclosure. In the example embodiment, system 200 may be used for performing payment-by-card transactions received as part of processing cardholder transactions. In addition, system 200 is a payment processing system that includes a rebate processing and monitoring (“RPM”) computing device 224 configured to complete rebate forms and monitor rebates. As described below in more detail, RPM computing device 224 is configured to store a plurality of cardholder profiles for registered cardholders, monitor transactions for those cardholders, determine purchases of those cardholders that qualify for rebates, complete the rebate forms, submit the completed forms, and monitor the rebates.

In the example embodiment, client systems 214 are computers that include a web browser or a software application, which enables client systems 214 to access server system 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, or other web-based connectable equipment.

A database server 216 is communicatively coupled to a database 220 that stores data. In one embodiment, database 220 includes transaction information from a plurality of cardholders and paths based on those transactions. In the example embodiment, database 220 is stored remotely from server system 212. In some embodiments, database 220 is decentralized. In the example embodiment, a person can access database 220 via client systems 214 by logging onto server system 212, as described herein.

RPM computing device 224 is communicatively coupled with the server system 212. RPM computing device 224 can access the server system 212 to store and access data and to communicate with the client systems 214 through the server system 212. RPM computing device 224 can also communicate with client systems 214 directly. In the example embodiment, RPM computing device 224 is communicatively coupled with a rebate clearinghouse 210. In some embodiments, RPM computing device 224 may be associated with, or is part of the payment system, or in communication with the payment card system payment processing network 120, shown in FIG. 1.

One or more point of sale systems 222 are communicatively coupled with the server system 212. The one or more point of sale systems 222 can be merchants 124 shown in FIG. 1, where the point of sale systems 222 are communicatively coupled with the server system through the payment processing network 120. Point of sale systems 222 may be, but are not limited to, machines that accept card swipes, online payment portals, or stored payment card numbers for recurring transactions.

In some embodiments, server system 212 may be associated with a financial transaction interchange network 128 shown in FIG. 1, and may be referred to as an interchange computer system. Server system 212 may be used for processing transaction data and analyzing for fraudulent transactions. In addition, at least one of client systems 214 may include a computer system associated with an issuer of a transaction card. Accordingly, server system 212 and client systems 214 may be utilized to process transaction data relating to purchases a cardholder makes utilizing a transaction card processed by the interchange network and issued by the associated issuer. At least one client system 214 may be associated with a user or a cardholder seeking to register, access information, or process a transaction with at least one of the interchange network, the issuer, or the merchant. In addition, client systems 214 or point of sale systems 222 may include point-of-sale (POS) devices associated with a merchant and used for processing payment transactions.

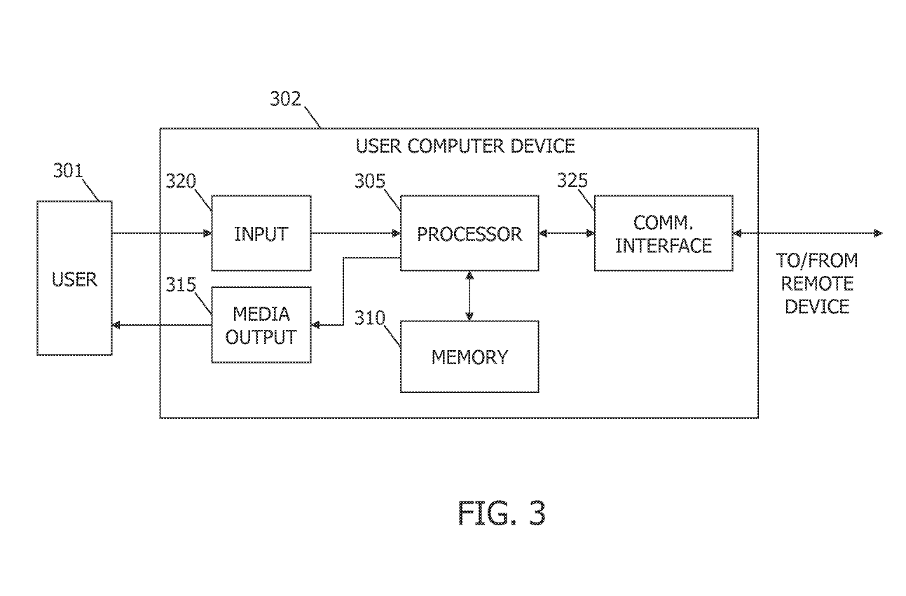

FIG. 3 illustrates an example configuration of client system 214 shown in FIG. 2, in accordance with one embodiment of the present disclosure. User computer device 302 is operated by a user 301. User computer device 302 may include, but is not limited to, client systems 214 and RPM computing device 224 (both shown in FIG. 2). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as server system 212 (shown in FIG. 2). Communication interface 325 may include, for example, a wired or wireless network adapter and/or a wireless data transceiver for use with a mobile telecommunications network.

Stored in memory area 310 are, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from server system 212. A client application allows user 301 to interact with, for example, server system 212. For example, instructions may be stored by a cloud service, and the output of the execution of the instructions sent to the media output component 315.

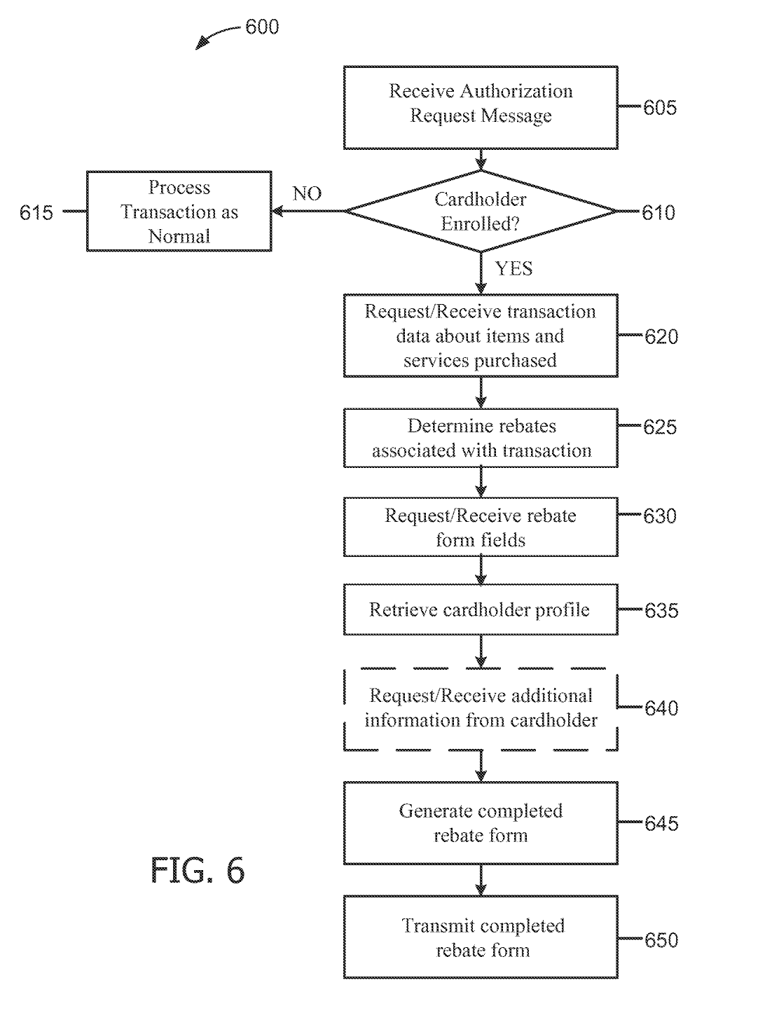

Processor 305 executes computer-executable instructions for implementing aspects of the disclosure. In some embodiments, the processor 305 is transformed into a special purpose microprocessor by executing computer-executable instructions or by otherwise being programmed. For example, the processor 305 is programmed with the instruction such as illustrated in FIG. 6.

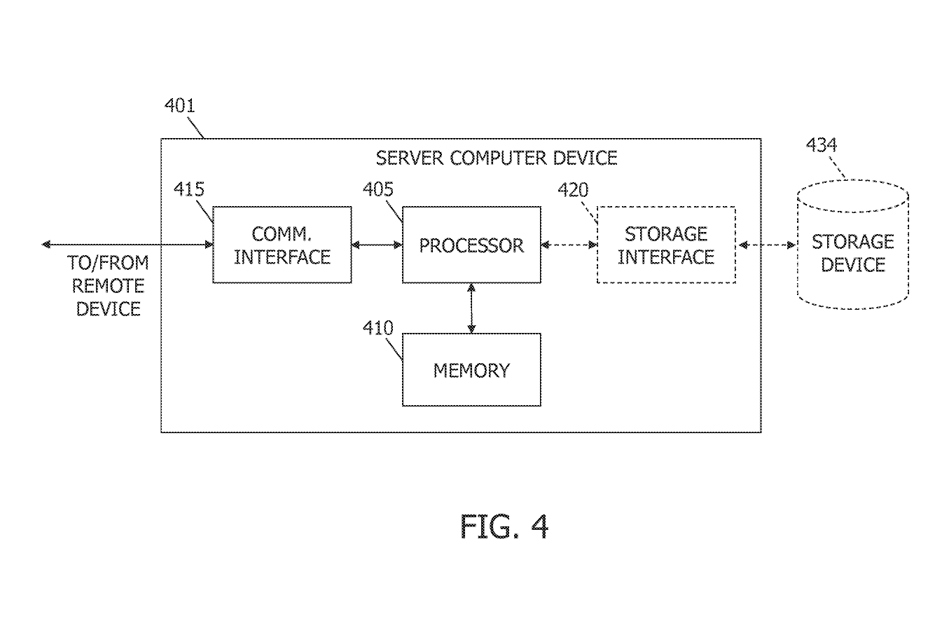

FIG. 4 illustrates an example configuration of server system 212 shown in FIG. 2, in accordance with one embodiment of the present disclosure. Server computer device 401 may include, but is not limited to, database server 216 and rebate clearinghouse 210 (both shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as another server computer device 401, client systems 214, or RPM computing device 224 (both shown in FIG. 2). For example, communication interface 415 may receive requests from client systems 214 via the Internet, as illustrated in FIG. 2.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

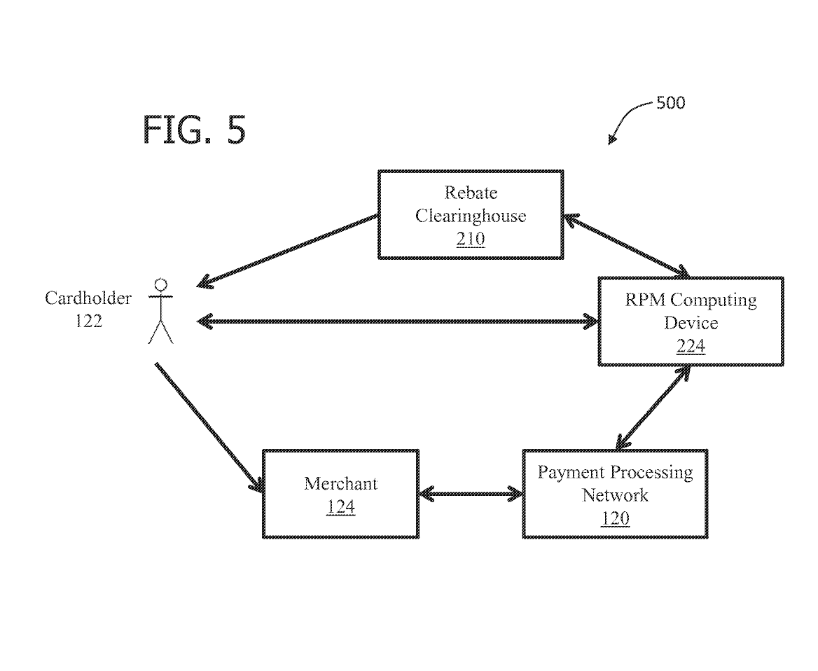

FIG. 5 is a block diagram illustrating an example system 500 for registering a cardholder 122, monitoring a cardholder's payment transactions, completing rebate forms, and monitoring rebates using the system shown in FIG. 2, in accordance with one embodiment of the disclosure. System 500 includes RPM computing device 224, merchant 124, payment processing network 120, and rebate clearinghouse 210. In the example embodiment, cardholder 122 registers for a rebate monitoring service via RPM computing device 224. RPM computing device 224 receives registration information from cardholder 122 via cardholder's client system 214 (shown in FIG. 2). In the example embodiment, RPM computing device 224 provides a webpage interface for cardholder 122 to register through. RPM computing device 224 enrolls cardholder 122 in the rebate monitoring service, creates a cardholder profile based on the registration information, and associates the cardholder profile with at least one payment card identifier. RPM computing device 224 stores the cardholder profile in database 220 (shown in FIG. 2). Cardholder 122 may update the information in the cardholder profile by logging into the webpage interface provided by RPM computing device 224. The registration data contains information required for RPM computing device 224 to identify the cardholder and to fill out the rebate forms. Registration information may include, but is not limited to, username, password, name, physical address, e-mail address, phone number, desire to opt-in for mailings, and one or more unique payment card identifiers, such as the cardholder's payment card number.

RPM computing device 224 monitors payment transactions initiated by cardholder 122 for items or services purchased by cardholder 122 that qualify for rebates. In some embodiments, RPM computing device 224 receives, stores, and maintains a list of available rebate offers provided by rebate clearinghouse 210. In other embodiments, RPM computing device 224 queries rebate clearinghouse 210 about individual items in a payment transaction. In the example embodiment, RPM computing device 224 monitors cardholder payment transactions by receiving authorization request messages from payment processing network 120. In other embodiments, RPM computing device 224 provides payment processing network 120 with a list of cardholders that registered for the rebate monitoring service and receives from payment processing network 120 every payment transaction, or a small subset of payment transactions, initiated by each registered cardholder's payment card including any available additional data about the payment transaction (described in FIG. 1).

As shown in FIG. 1, cardholder 122 tenders payment for a purchase from merchant 124 with a payment account card. For example, tendering of payment may be done at point of sale system 222 (shown in FIG. 2). Merchant 124 sends an authorization request that contains transaction data, including a payment card identifier, of the payment transaction to payment processing network 120. In the example embodiment, payment processing network 120 transmits the transaction data from the authorization request to RPM computing device 224. The transmission may be from merchant bank 126, interchange network 128, or issuer bank 130 (all shown in FIG. 1). In other embodiments, RPM computing device 224 may be a part of payment processing network 120 and receive the authorization request as a part of normal payment transaction processing.

Using the payment card identifier associated with the payment transaction, RPM computing device 224 queries database 220 to determine if the payment card identifier is associated with a cardholder profile. If the determination is yes, then RPM computing device 224 requests additional information about the payment transaction from merchant 124. In the example embodiment, payment processing network 120 includes this request with the authorization code approving the payment transaction. In the example embodiment, merchant 124 transmits the additional information about only the items purchased that are eligible for a rebate to RPM computing device 224. This additional information may include, but is not limited to, UPC codes, product listings, and copies of the receipt. In other embodiments, merchant 124 transmits additional information about all of the items purchased and RPM computing device 224 compares the items purchase to the stored list of available rebate offers to determine which items are eligible for rebates.

In the example embodiment, once RPM computing device 224 determines which purchased items are eligible for rebates, RPM computing device 224 requests the required rebate form fields from rebate clearinghouse 210 for each eligible item. In other embodiments, RPM computing device 224 stores the required rebate form fields in database 220 and retrieves the rebate form fields for the eligible items.

For each eligible item, RPM computing device 224 completes the rebate form corresponding to the eligible item. RPM computing device 224 uses the payment transaction, the additional information received from merchant 124, and the cardholder profile to fill in the fields of the rebate form. If there are fields that RPM computing device 224 lacks the information to complete, then RPM computing device 224 requests that information from cardholder 122. This request may be sent to cardholder 122 via e-mail, text message, or other communication method. In the case of some rebates, the physical copy of the UPC code from the packaging of the item purchased may be required to process the rebate. In these cases, RPM computing device 224 will instruct cardholder 122 where to send the UPC code to. In other cases, only a picture of the UPC code from the packaging may be necessary and RPM computing device 224 receives the picture from cardholder 122.

Once RPM computing device 224 has competed all of the required fields, RPM computing device 224 transmits the completed rebate form. In the example embodiment, RPM computing device 224 transmits the completed form directly to rebate clearinghouse 210 for processing. In other embodiments, RPM computing device 224 transmits the completed rebate form to payment processing network 120, which then transmits the completed rebate form to rebate clearinghouse 210. In still other embodiments, RPM computing device 224 transmits the completed rebate form directly to the manufacturer that is offering the rebate.

RPM computing device 224 periodically communicates with rebate clearinghouse 210 or the manufacturer to determine the status of the rebate. When cardholder 122 logs into RPM computing device 224, RPM computing device 224 displays the current status of every rebate associated with cardholder 122. In some embodiments, RPM computing device 224 also transmits updates directly to cardholder 122 via e-mail, text, or other communication methods. These updates may be sent when the status of a rebate changes or periodically.

Some rebates require the purchase of multiple items; therefore, in some embodiments RPM computing device 224 tracks the items and services purchased by cardholder 122. When cardholder 122 reaches the required number of items, RPM computing device 224 completes the corresponding rebate form and submits the completed form to rebate clearinghouse 210. For example, if cardholder 122 purchased three boxes of cereal and the rebate is for purchasing four boxes, then RPM computing device 224 stores the payment transaction and additional information for the purchase of the boxes. When cardholder 122 purchases the fourth box, RPM computing device 224 combines the two payment transactions and submits the rebate.

In some embodiments, when merchant 124 is processing a return, RPM computing device 224 receives a request from merchant 124. The request is an inquiry if a rebate has been processed for returning cardholder 122 on the item or items being returned. RPM computing device 224 transmits the existence of a rebate in process or completed to the requesting merchant 124.

In other embodiments, RPM computing device 224 instructs rebate clearinghouse 210 to transmit the rebate to payment processing network 120 instead of cardholder 122. RPM computing device 224 instructs payment processing network 120 to credit cardholder's account 132 (shown in FIG. 1) by the amount of the rebate. In this manner, cardholder 122 receives his or her rebate immediately as payment processing network 120 advances cardholder 122 the rebate amount.

FIG. 6 is a flowchart illustrating an example process 600 of processing a payment transaction that contains an item that is eligible for a rebate using the system shown in FIG. 2, in accordance with one embodiment of the disclosure. Process 600 uses a RPM computing device 224, shown in FIG. 2. RPM computing device 224 receives 605 an authorization request message. The authorization request message is generated when cardholder 122 initiates a transaction using a payment card. In the example embodiment, the authorization request message is received from interchange network 128 (shown in FIG. 1). In other embodiments, authorization request message could be sent by merchant 124, merchant bank 126, and issuer bank 130 (all shown in FIG. 1). The authorization request message includes information about the payment transaction including, but not limited to, transaction amount, merchant identifier, and payment card identifier.

When RPM computing device 224 receives an authorization request message, RPM computing device 224 determines 610 if the cardholder associated with the payment transaction is registered for the rebate monitoring service. RPM computing device 224 retrieves the payment card identifier from the authorization request message. Then RPM computing device 224 queries database 220 (shown in FIG. 1) to determine if the payment card identifier matches any cardholder profile stored in database 220. If RPM computing device 224 determines that that the cardholder is not registered for the rebate monitoring service, then RPM computing device 224 takes no further action and the payment transaction is processed as normal 615 as described in FIG. 1.

If RPM computing device 224 determines that that the cardholder is registered for the rebate monitoring service, then RPM computing device 224 requests and receives 620 transaction data about the items and services purchased in the payment transaction. In the example embodiment, RPM computing device 224 requests 620 the information from merchant 124. The transaction data may include, but is not limited to, UPC codes, product listings, and copies of the receipt. From the transaction data, RPM computing device 224 determines 625 the rebates associated with the items in the payment transaction. In the example embodiment, RPM computing device 224 compares the items purchased with a list of available rebates. In other embodiments, merchant 124 only sends transaction data about items eligible for rebates.

For the eligible items, RPM computing device 224 requests and receives 630 the rebate form fields for the corresponding rebates. In the example embodiment, RPM computing device 224 requests and receives 630 the rebate form fields from rebate clearinghouse 210 (shown in FIG. 2). In other embodiments, RPM computing device 224 stores the rebate form fields for every rebate available in database 220. RPM computing device 224 retrieves 635 the cardholder profile corresponding to cardholder 122 associated with the payment transaction.

In some situations, RPM computing device 224 may require additional information from cardholder 122 to complete the rebate. In these situations, RPM computing device 224 requests and receives 640 additional information from cardholder 122. This communication may be via e-mail, text message, or other communication method. In some embodiments, RPM computing device 224 may be configured for cardholder 122 to log into RPM computing device 224 to provide the requested information. In the case of some rebates, the physical copy of the UPC code from the packaging of the item purchased may be required to process the rebate. In these cases, RPM computing device 224 will instruct cardholder 122 where to send the UPC code to. In other cases, only a picture of the UPC code from the packaging may be necessary and RPM computing device 224 will receive the picture from cardholder 122.

Once RPM computing device 224 has all of the information for the rebate form fields, RPM computing device 224 generates a completed rebate form for each eligible item. In the example embodiment, RPM computing device 224 will generate a completed form when all of the fields of the rebate for an item are ready, even if other items from the same payment transaction still require additional information to complete corresponding rebates. RPM computing device 224 transmits 650 the completed rebate form. In the example embodiment, RPM computing device transmits the completed form to rebate clearinghouse 210. In other embodiments, RPM computing device 224 transmits 650 the completed form to the payment processing network 120 or directly to the manufacturer offering the rebate.

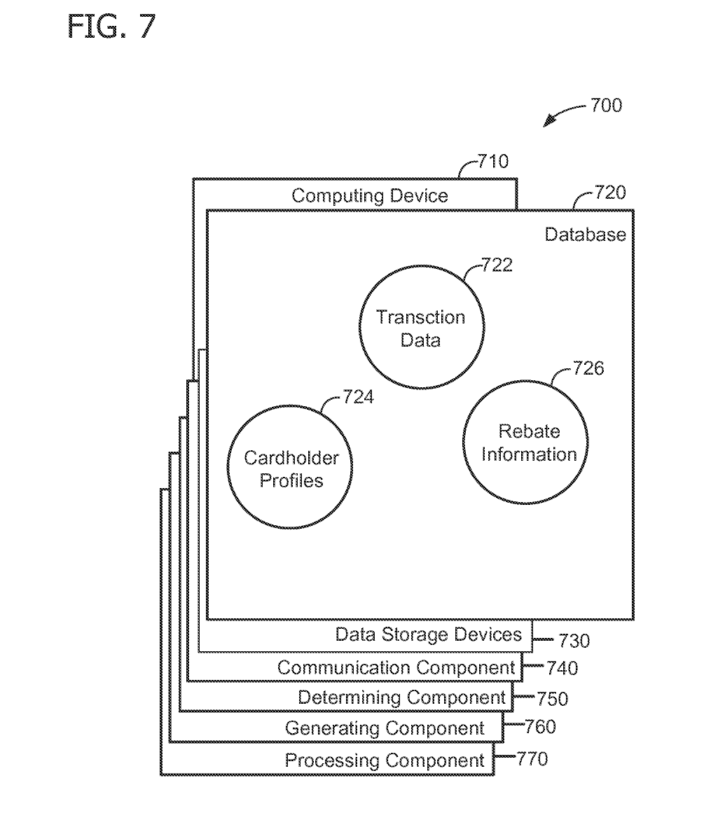

FIG. 7 is a diagram 700 of components of one or more example computing devices that may be used in system 200 shown in FIG. 2. In some embodiments, computing device 710 is similar to server system 212; it may also be similar to RPM computing device 224 (both shown in FIG. 2). Database 720 may be coupled with several separate components within computing device 710, which perform specific tasks. In this embodiment, database 720 includes transaction data 722, cardholder profiles 724, and rebate information 726. In some embodiments, database 720 is similar to database 220 (shown in FIG. 2).

Computing device 710 includes the database 720, as well as data storage devices 730. Computing device 710 also includes a communication component 740 for receiving 605 an authorization request message, requesting/receiving 620 transaction data, requesting/receiving 630 rebate form fields, requesting/receiving 640 additional information from cardholder, and transmitting 650 the completed form (all shown in FIG. 6). Computing device 710 also includes a determining component 760 for determining 610 whether the cardholder is enrolled in the rebate monitoring service and determining 625 which rebates are associated with the payment transaction, both shown in FIG. 6. A generating component 750 is also included for generating 645 a completed rebate form, as shown in FIG. 6. A processing component 770 assists with execution of computer-executable instructions associated with the system.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-based method for processing and monitoring rebates associated with a cardholder, said method implemented using a rebate computing device in communication with a memory, said method comprising:
storing data within the memory including (i) a plurality of cardholder profiles each associated with a cardholder enrolled in a rebate monitoring service, and (ii) a plurality of payment card identifiers each associated with one of the cardholders;
receiving a first authorization request message for a first payment transaction initiated by a first cardholder using a first payment card at a first merchant, the first authorization request message including a first payment card identifier;
determining, by the computing device, a first cardholder profile associated with the first cardholder for the rebate monitoring service based in part on the first payment card identifier and the data stored in the memory;
determining, by the computing device, at least a first rebate associated with the first payment transaction;
generating, by the computing device, a completed rebate form based in part on the first cardholder profile and the first payment transaction; and
transmitting the completed rebate form.

2. The method in accordance with claim 1, further comprising:
receiving a second authorization request message for a second payment transaction initiated by the first cardholder; and
determining, by the computing device, at least a second rebate associated with the first payment transaction and the second payment transaction, wherein the second rebate is based on at least one item included in the first payment and at least one item included in the second payment transaction.

3. The method in accordance with claim 1, further comprising:
receiving registration information from a cardholder, including one or more of username, password, name, physical address, e-mail address, phone number, desire to opt-in for mailings, and one or more unique payment card identifiers;
enrolling the cardholder in the rebate monitoring service; and
storing, in the memory, a cardholder profile associated with the cardholder and based on the registration information.

4. The method in accordance with claim 1, further comprising:
receiving, from a merchant, a request to determine whether a completed rebate form has been transmitted for at least one item including at least one item identifier and a payment card identifier;
determining, by the computing device, whether the completed rebate form has been transmitted for the at least one item based on the at least one item identifier and the payment card identifier; and
transmitting, to the merchant, the determination.

5. The method in accordance with claim 1, further comprising:
storing, in the memory, a status of the first rebate associated with the first cardholder profile;
receiving, by the computing device, an update of the status of the first rebate; and
transmitting, to the first cardholder, the updated status of the first rebate.

6. The method in accordance with claim 5, further comprising transmitting, to a rebate clearinghouse computing device, a request for the update of the status of the first rebate.

7. The method in accordance with claim 1, wherein generating a completed form further comprises:
determining, by the computing device, one or more fields of a rebate form that required additional information not included in the first payment transaction or the first cardholder profile;
transmitting, to the first cardholder, a request to provide the additional information to fill out the one or more fields; and
receiving, from the first cardholder, the additional information to complete the one or more fields.

8. The method in accordance with claim 1, further comprising:
determining that a physical proof of purchase is required to complete a rebate form; and
transmitting to the first cardholder, instructions for sending the physical proof of purchase.

9. The method in accordance with claim 1, wherein determining at least one rebate further comprises:
transmitting, to the first merchant, a request for a list of one or more items purchased in the first transaction;
receiving, from the first merchant, the list of one or more items purchased in the first transaction; and
determining for each item on the list of one or more items purchased whether a rebate is associated with the purchase of that item.

10. A rebate computer system for processing and monitoring rebates associated with a cardholder, said computer system comprising:
a memory device for storing data; and
one or more processors in communication with said memory device, said one or more processors programmed to:
store data within the memory device including (i) a plurality of cardholder profiles each associated with a cardholder enrolled in a rebate monitoring service, and (ii) a plurality of payment card identifiers each associated with one of the cardholders;
receive a first authorization request message for a first payment transaction initiated by a first cardholder using a first payment card at a first merchant, the first authorization request message including a first payment card identifier;
determine a first cardholder profile associated with the first cardholder for the rebate monitoring service based in part on the first payment card identifier and the data stored in the memory device;
determine at least a first rebate associated with the first payment transaction;
generate a completed rebate form based in part on the first cardholder profile and the first payment transaction; and
transmit the completed rebate form.

11. The rebate computer system in accordance with claim 10, wherein said processor is further programmed to:
receive a second authorization request message for a second payment transaction initiated by the first cardholder; and
determine at least one rebate associated with the first payment transaction and the second payment transaction, wherein the second rebate is based on at least one item included in the first payment and at least one item included in the second payment transaction.

12. The rebate computer system in accordance with claim 10, wherein said processor is further programmed to:
receive registration information from a cardholder, including one or more of username, password, name, physical address, e-mail address, phone number, desire to opt-in for mailings, and one or more unique payment card identifiers;
enroll the cardholder in the rebate monitoring service; and
store a cardholder profile associated with the cardholder and based on the registration information.

13. The rebate computer system in accordance with claim 10, wherein said processor is further programmed to:
receive, from a merchant, a request to determine whether a completed rebate form has been transmitted for at least one item including at least one item identifier and a payment card identifier;
determine whether the completed rebate form has been transmitted for the at least one item based on the at least one item identifier and the payment card identifier; and
transmit the determination to the merchant.

14. The rebate computer system in accordance with claim 10, wherein said processor is further programmed to:
store a status of the first rebate associated with the first cardholder profile;
receive an update for the status of the first rebate; and
transmit the updated status of the first rebate to the first cardholder.

15. The rebate computer system in accordance with claim 14, wherein said processor is further programmed to transmit a request for the update of the status of the first rebate.

16. The rebate computer system in accordance with claim 10, wherein said processor is further programmed to:
determine one or more fields of a rebate form that require additional information not included in the first payment transaction or the first cardholder profile associated with the first cardholder;
transmit, to the first cardholder, a request to provide the additional information to fill out the one or more fields; and
receive, from the first cardholder, the additional information to complete the one or more fields.

17. The rebate computer system in accordance with claim 10, wherein said processor is further programmed to:
determine that a physical proof of purchase is required to complete a rebate form; and
transmit to the first cardholder, instructions for sending the physical proof of purchase.

18. The rebate computer system in accordance with claim 10, wherein said processor is further programmed to:
transmit, to the first merchant, a request for a list of one or more items purchased in the first transaction;
receive, from the first merchant the list of one or more items purchased in the first transaction; and
determine for each item on the list of one or more items purchased whether a rebate is associated with the purchase of that item.

19. A computer-readable storage medium having computer-executable instructions embodied thereon, wherein when executed by a computing device having at least one processor coupled to a memory device, the computer-executable instructions cause the processor to:
store data within the memory device including (i) a plurality of cardholder profiles each associated with a cardholder enrolled in a rebate monitoring service, and (ii) a plurality of payment card identifiers each associated with one of the cardholders;
receive a first authorization request message for a first payment transaction initiated by a first cardholder using a first payment card at a first merchant, the first authorization request message including a first payment card identifier;
determine a first cardholder profile associated with the first cardholder for the rebate monitoring service based in part on the first payment card identifier and the data stored in the memory device;
determine at least a first rebate associated with the first payment transaction;
generate a completed rebate form based in part on the first cardholder profile and the first payment transaction; and
transmit the completed rebate form.

20. The computer-readable storage medium of claim 19, wherein the computer-executable instructions further cause the processor to:
receive a second authorization request message for a second payment transaction initiated by the first cardholder; and
determine at least one rebate associated with the first payment transaction and the second payment transaction, wherein the second rebate is based on at least one item included in the first payment and at least one item included in the second payment transaction.
